(19) United States
(12) Patent Application Publication
(10) Pub. No.: US 2025/0150733 A1
(43) Pub. Date: May 8, 2025

(54) IMAGE SENSOR

(71) Applicant: SAMSUNG ELECTRONICS CO., LTD., Suwon-si (KR)

(72) Inventors: Je Yeoun JUNG, Suwon-si (KR); Sang Yoon KIM, Suwon-si (KR); Seung Sik KIM, Suwon-si (KR); Hyeon Woo LEE, Suwon-si (KR); Jae Hoon JEON, Suwon-si (KR)

(21) Appl. No.: 18/783,876

(22) Filed: Jul. 25, 2024

(30) Foreign Application Priority Data
Nov. 7, 2023 (KR) 10-2023-0152323

(51) Int. Cl. H04N 25/771; H04N 25/532; H04N 25/79

(52) U.S. Cl. CPC H04N 25/771; H04N 25/532; H04N 25/79

(57) ABSTRACT

An image sensor includes a first semiconductor chip which extends in first and second directions that intersect each other, and having a pixel part including a plurality of pixel regions; and a second semiconductor chip including a circuit part electrically connected to the pixel part, on the first semiconductor chip. The pixel part includes a photodiode, a floating diffusion node which accumulates photocharges generated by the photodiode, and a first source follower which amplifies and outputs a signal corresponding to a change in potential of the floating diffusion node. The circuit part includes a first pre-charge selection transistor connected between a first node and a second node, a second pre-charge selection transistor connected to the first pre-charge selection transistor, and a pre-charge transistor which pre-charges the second node connected to the first source follower. The plurality of pixel regions share the pre-charge transistor.

### CROSS-REFERENCE TO RELATED APPLICATION

This patent application claims priority under 35 U.S.C. 119 to Korean Patent Application No. 10-2023-0152323 filed on Nov. 7, 2023 in the Korean Intellectual Property Office, the disclosure of which is incorporated by reference in its entirety herein.

### 1. TECHNICAL FIELD

The present disclosure relates to an image sensor.

### 2. DISCUSSION OF RELATED ART

An image sensing device is a semiconductor element that convert optical information into an electric signal. Such an image sensing device may include a charge coupled device (CCD) image sensing device and a complementary metal-oxide semiconductor (CMOS) image sensing device.

The CMOS image sensor may be abbreviated as a CIS (CMOS image sensor). The CIS may include a plurality of pixels arranged two-dimensionally. For example, each of the pixels may include a photodiode (PD). A photodiode to converts incident light into electrical signals.

Image sensors are used in various fields, such as a digital camera, a video camera, a smart phone, a game console, a security camera, a medical micro camera, and a robot have increased. However, the performance and reliability of image sensors need to be increased to support present computer and telecommunication industries.

### SUMMARY

Aspects of the present disclosure provide an image sensor having increased performance and reliability.

An image sensor according to an embodiment of the present disclosure includes a first semiconductor chip which extends in first and second directions that intersect each other, and includes a pixel part having a plurality of pixel regions; and a second semiconductor chip including a circuit part electrically connected to the pixel part, on the first semiconductor chip. The pixel part includes a photodiode, a floating diffusion node which accumulates photocharges generated by the photodiode, and a first source follower which amplifies and outputs a signal corresponding to a change in potential of the floating diffusion node. The circuit part includes a first pre-charge selection transistor connected between a first node and a second node, a second pre-charge selection transistor connected to the first pre-charge selection transistor, and a pre-charge transistor which pre-charges the second node connected to the first source follower. The plurality of pixel regions share the pre-charge transistor.

An image sensor according to an embodiment of the present disclosure includes a first semiconductor chip including a pixel part having first and second pixel regions adjacent to one another; and a second semiconductor chip including a circuit part for performing a global shutter operation, on the first semiconductor chip. The pixel part includes a photodiode, a floating diffusion node which accumulates photocharges generated by the photodiode, and a first source follower which amplifies and outputs a signal corresponding to a change in potential of the floating diffusion node, in which the circuit part includes a first pre-charge selection transistor connected between the first node and the second node, a second pre-charge selection transistor connected to the first pre-charge selection transistor, and a pre-charge transistor which pre-charges the second node connected to the first source follower. The pre-charge transistor includes a first pre-charge transistor connected to a first_1 pre-charge selection transistor of the first pixel region and a second_1 pre-charge selection transistor of the second pixel region, and a second pre-charge transistor connected to a second_2 pre-charge selection transistor of the first pixel region and a first_2 pre-charge selection transistor of the second pixel region.

An image sensor according to an embodiment of the present disclosure includes a first substrate which includes a pixel part having first and second pixel regions; a second substrate bonded to the first substrate through a bonding structure, and includes a circuit part electrically connected to the first substrate; and a third substrate which is electrically connected to the second substrate, on the second substrate. The pixel part includes a photodiode, a floating diffusion node which accumulates photocharges generated by the photodiode, and a first source follower which amplifies and outputs a voltage of the floating diffusion node. The circuit part includes a first capacitor that stores electric charges according to a voltage of the floating diffusion node being reset, a second capacitor that stores electric charges according to the voltage of the floating diffusion node in which the photocharges are stored, a first sampling transistor connected to a first node, and samples electric charges to the first capacitor, a second sampling transistor connected to the first node, and samples electric charge to the second capacitor, a first pre-charge selection transistor connected between the first node and the second node, a second pre-charge selection transistor connected to the first pre-charge selection transistor, and a pre-charge transistor which pre-charges the second node connected to the first source follower. The pre-charge transistor is disposed over the first and second pixel regions adjacent to each other, on the second substrate.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram showing a configuration of an image sensor according to an embodiment;

FIG. 2 is a diagram for explaining an operation of the image sensor in a global shutter mode according to an embodiment;

FIG. 3 is a circuit diagram of a pixel included in the image sensor according to an embodiment;

FIG. 4 is a timing diagram showing controls and ramp signals provided to pixels of the image sensor according to an embodiment;

FIG. 5 is a layout diagram schematically showing a pixel region of the image sensor according to an embodiment;

FIGS. 6 and 7 are diagrams for explaining a pre-charge transistor included in the circuit diagram of FIG. 3;

FIG. 8 is a cross-sectional view schematically showing the image sensor according to an embodiment;

FIGS. 9 and 10 are enlarged views of regions A1 and A2 of FIG. 8;

FIG. 11 is a circuit diagram of a pixel included in the image sensor according to an embodiment;

FIG. 12 is a layout diagram schematically showing a pixel region of the image sensor according to an embodiment; and

FIGS. 13 and 14 are block diagrams for explaining an electronic device including the image sensor according to an embodiment.

### DETAILED DESCRIPTION

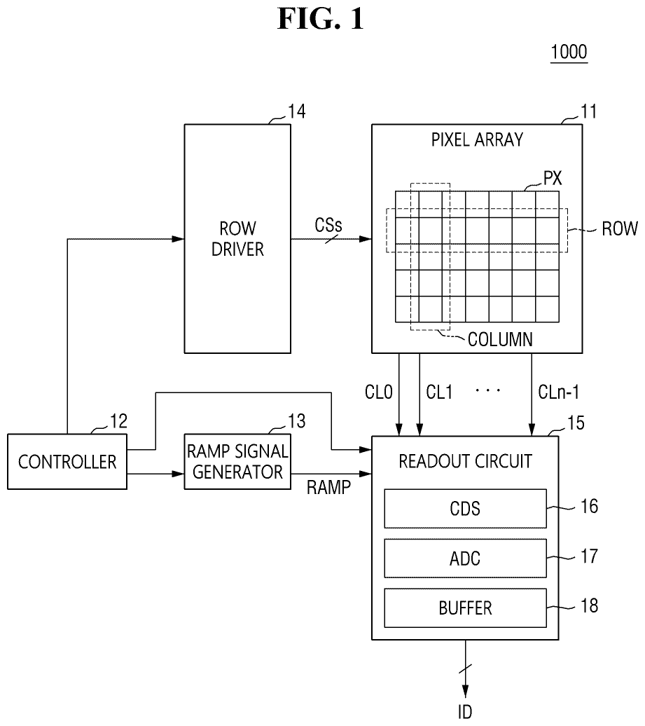

Hereinafter, to more specifically explain the present disclosure, some embodiments of the present disclosure will be described in more detail with reference to the accompanying drawings. An image sensor according to an embodiment will be described with reference to FIGS. 1 to 10.

FIG. 1 is a block diagram showing a configuration of the image sensor according to an embodiment.

An image processing system including an image sensor 1000 according to an embodiment includes an image sensor 1000 and a digital signal processor (DSP). The image sensor 1000 and the digital signal processor may each be implemented as a chip, or the image sensor 1000 and the digital signal processor may be implemented as one image sensor chip. The digital signal processor may perform signal processing on the basis of the image data ID. For example, the digital signal processor may perform noise reduction processing, gain adjustment, waveform shaping processing, interpolation processing, white balance processing, gamma processing or edge enhancement processing. For example, the digital signal processor may process the image data ID output by the image sensor 1000.

Referring to FIG. 1, the image sensor 1000 may include a pixel array 11, a controller 12 (e.g., a controller circuit), a ramp signal generator 13, a row driver 14, and a readout circuit 15. For example, the readout circuit 15 may include a correlated-double sampling circuit 16, an analog-digital converter 17 and a buffer 18.

The pixel array 11 may include a plurality of pixels PX. Each of the plurality of pixels PX may include a photoelectric conversion element, and may generate pixel signals corresponding to an object by converting light sensed by the photoelectric conversion element into an electrical signal. Each of the plurality of pixels PX may output the pixel signals to the readout circuit 15 through corresponding first to n-th column lines CL0 to CLn-1.

The plurality of pixels PX may be arranged in the pixel array 11 in the form of a matrix disposed in rows and columns. The plurality of pixels PX may be active pixel sensors (APS). An APS may include a pixel and one or more active transistors.

The controller 12 may control the operation of the row driver 14, the operation of the ramp signal generator 13, and the operation of the readout circuit 15. The controller 12 may include a control register block, and the control register block may control the operation of the row driver 14, the ramp signal generator 13, and the readout circuit 15 in accordance with control of the digital signal processor. In an exemplary embodiment, the controller 12 controls the row driver 14, the ramp signal generator 13, and the readout circuit 15 such that the image sensor 1000 operates in a global shutter mode.

The row driver 14 may generate control signals CSs for controlling the pixel array 11 and provide the control signal CSs to each of the plurality of pixels PX. In some embodiments, the row driver 14 may determine activation and deactivation timings of the control signal CSs for each of the plurality of pixels PX to operate in the global shutter mode.

The control signals CSs may be generated to correspond to each row of the pixel array 11 so that the pixel array 11 is controlled row by row. The pixel array 11 may output a reset signal and an image signal from one or more selected rows to the readout circuit 15 in response to the control signals CSs provided from the row driver 14.

The ramp signal generator 13 may generate a ramp signal RAMP. The ramp signal RAMP may be used for converting an analog signal into a digital signal, and may be generated to have the form of a triangular wave. The ramp signal generator 13 may provide the ramp signal RAMP to the readout circuit 15, for example, the correlated double sampling circuit 16.

The correlated double sampling circuit 16 may sample and hold pixel signals provided from the pixel array 11. The correlated double sampling circuit 16 may doubly sample a specific noise level, that is, the reset signal and the image signal to calculate a difference, and output a level corresponding to the difference. Further, the correlated double sampling circuit 16 may receive the ramp signals RAMP generated by the ramp signal generator 13, compare the received ramp signals RAMP with each other to generate comparison results, and output comparison results. The analog-digital converter 17 may convert the analog signal corresponding to the level received from the correlated double sampling circuit 16 into a digital signal. The buffer 18 may latch the digital signal and sequentially output the latched image data ID.

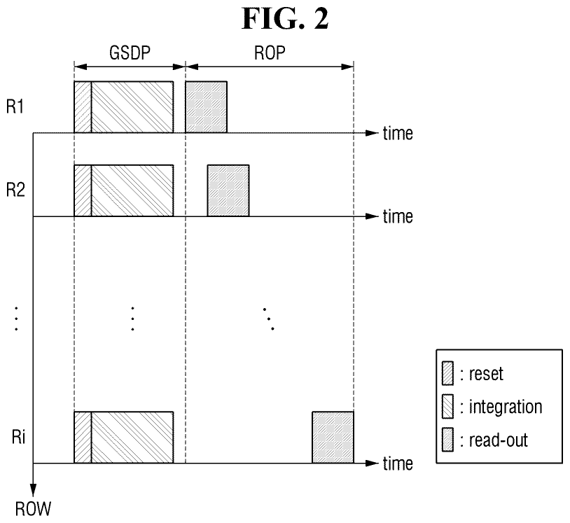

FIG. 2 is a diagram for explaining the operation of the image sensor in the global shutter mode according to an embodiment.

Referring to FIGS. 1 and 2, the image sensor 1000 may be driven in the global shutter mode. In the global shutter mode, the image sensor 1000 may perform a global signal dumping operation during a global signal dumping period (GSDP) and a readout operation during a readout period (ROP). The global signal dumping operation may include a reset operation that resets electric charges accumulated in a floating diffusion node, and an accumulation operation that accumulates photocharges generated by a photoelectric conversion element during an integration time.

In the global signal dumping period (GSDP), the image sensor 1000 may perform a control such that a reset time, which is a time during which the reset operation is performed on different rows, for example, the first to i-th rows (R1 to Ri, i is a natural number of 2 or more) is equal to the electric charge integration time during which the accumulation operation is performed. The integration time may mean a time for substantially accumulating photoelectric charges generated by a photoelectric conversion element, for example, a photodiode, included in each of the plurality of pixels PX.

In the readout period (ROP), a rolling readout operation in which the readout operation is sequentially performed for each row may be performed. The image sensor 1000 may be controlled to sequentially perform the readout operation from the first row R1 to the i-th row Ri during the readout time. The readout time may mean the time during which the pixel signals corresponding to the photocharges generated in each of the plurality of pixels PX are output from each of the plurality of pixels PX.

When the image sensor 1000 according to an embodiments operates in the global shutter mode, it is possible to equally control the photocharge integration time points of pixels PX disposed in different rows, and remove distortion of image due to the difference in photocharge integration time.

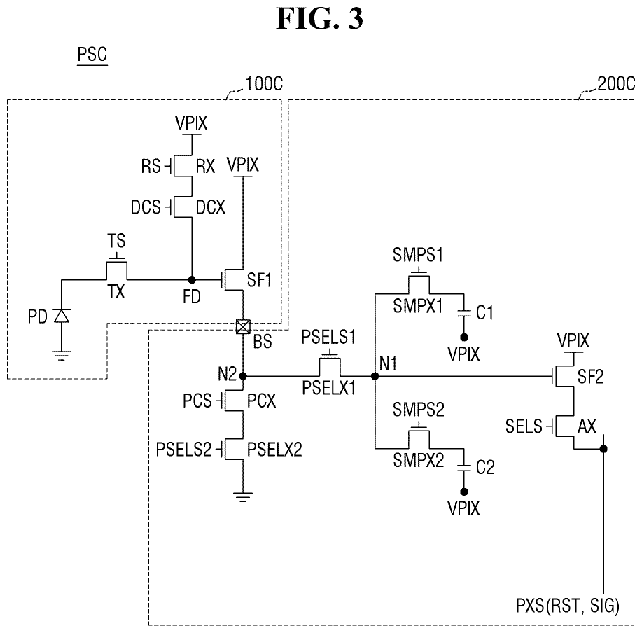

FIG. 3 is a circuit diagram of the pixel included in the image sensor according to an embodiment.

Referring to FIGS. 1 and 3, the pixel PX includes a pixel signal generation circuit PSC that generates a pixel signal PXS. Control signals TS, RS, DCS, PSELS1, PSELS2, PCS, SMPS1, SMPS2, and SELS applied to the pixel signal generation circuit PSC may be some of the control signals CSs generated by the row driver 12.

The pixel signal generation circuit PSC includes a pixel part 100C and a circuit part 200C (e.g., a pixel circuit). The pixel part 100C may be included in a first semiconductor chip 100, which will be described later, and the circuit part 200C may be included in a second semiconductor chip 200.

The pixel part 100C includes a photodiode PD, a transfer transistor TX, a reset transistor RX, a conversion gain transistor DCX, a floating diffusion node FD, and a first source follower SF1 (e.g., a first source follower transistor).

The circuit part 200C includes a first pre-charge selection transistor PSELX1, a second pre-charge selection transistor PSELX2, a pre-charge transistor PCX, a first sampling transistor SMPX1, a second sampling transistor SMPX2, a first capacitor C1, a second capacitor C2, a second source follower SF2 (e.g., a second source follower transistor), and a selection transistor AX. Electric charges corresponding to the reset operation may be accumulated in each of the first capacitor C1 and the second capacitor C2, or electric charges corresponding to the photocharge accumulation operation may be accumulated in each of the first capacitor C1 and the second capacitor C2.

The photodiode PD may generate photocharges that vary depending on the intensity of light. For example, the photodiode PD may generate electric charges, that is, electrons which are negative charges, and holes which are positive charges, in proportion to the quantity of incident light. The photodiode PD may be at least one of a phototransistor, a photogate, a pinned photodiode (PPD), and a combination thereof, as an example of the photoelectric conversion element.

The transfer transistor TX is connected between the photodiode PD and the floating diffusion node FD. A first terminal of the transfer transistor TX is connected to an output terminal of the photodiode PD, and a second terminal of the transfer transistor TX is connected to the floating diffusion node FD. The transfer transistor TX may be turned on or off in response to the transfer control signal TS received from the row driver 12, and may output the photocharges generated by the photodiode PD to the floating diffusion node (FD). For example, a gate of the transfer transistor TX may receive the transfer control signal TS. The floating diffusion node FD may have parasitic capacitance.

The reset transistor RX may reset the electric charges accumulated in the floating diffusion node FD. A pixel voltage VPIX is applied to a first terminal of the reset transistor RX, and the second terminal of the reset transistor RX is connected to a conversion gain transistor DCX. The reset transistor RX may be turned on or off by the reset control signal RS received from the row driver 12, and the conversion gain transistor DCX may be turned on or off in response to the conversion gain control signal DCS received from the row driver 12. For example, a gate of the reset transistor RX may receive the reset control signal RS. When the reset transistor RX and the conversion gain transistor DCX are turned on, the electric charges accumulated in the floating diffusion node FD are discharged, and the floating diffusion node FD may be reset.

The first terminal of the conversion gain transistor DCX is connected to the reset transistor RX, and the second terminal of the conversion gain transistor DCX is connected to the floating diffusion node FD.

The conversion gain transistor DCX adjust a conversion gain. For example, the conversion gain may be adjusted by applying a logic high level signal or a logic low level signal to the gate of the conversion gain transistor DCX.

In an embodiment, the first source follower SF1 is a buffer amplifier, and buffers a signal according to the amount of electric charges accumulated in the floating diffusion node FD. The pixel voltage VPIX is applied to the first terminal of the first source follower SF1, and the second terminal of the first source follower SF1 is connected to a second node N2. The potential of the floating diffusion node FD may change depending on the amount of electric charges accumulated in the floating diffusion node FD. As the potential of the floating diffusion node FD changes, the first source follower SF1 may amplify the signal corresponding to the change in the potential of the floating diffusion node FD to generate an amplified result, and output the amplified result to the second node N2.

A first terminal of the pre-charge transistor PCX is connected to the second node N2, and a second terminal of the pre-charge transistor PCX is connected to the second pre-charge selection transistor PSELX2. The pre-charge transistor PCX may pre-charge the second node N2 according to the pre-charge control signal PCS received from the row driver 12. For example, the pre-charge control signal PCS may be applied to a gate of the pre-charge transistor PCX.

The first pre-charge selection transistor PSELX1 is connected between the second node N2 and the first node N1. The first pre-charge selection transistor PSELX1 may be turned on or off in response to the first pre-charge selection control signal PSELS1 received from the row driver 12, and may reset the first node N1. For example, the first pre-charge selection control signal PSELS1 may be applied to a gate of the first pre-charge selection transistor PSELX1. The first node N1 may have a parasitic capacitance.

The first terminal of the second pre-charge selection transistor PSELX2 is connected to the pre-charge transistor PCX, and a ground voltage may be applied to the second terminal of the second pre-charge selection transistor PSELX2. The second pre-charge selection transistor PSELX2 may be turned on or off in response to the second pre-charge selection control signal PSELS2 received from the row driver 12, and may reset the second node N2. For example, the second pre-charge selection control signal PSELS2 may be applied to a gate of the second pre-charge selection transistor PSELX2. That is, the first source follower SF1, the pre-charge transistor PCX, and the second pre-charge selection transistor PSELX2 may be connected in series.

The first terminal of the first sampling transistor SMPX1 is connected to the first node N1, and the second terminal of the first sampling transistor SMPX1 is connected to the first capacitor C1. The first sampling transistor SMPX1 may be turned on or off in response to the first sampling control signal SMPS1 received from the row driver 12, and the first capacitor C1 and the first node N1 may be connected. For example, the first sampling control signal SMPS1 may be applied to the gate of the first sampling transistor SMPX1.

The pixel voltage VPIX is applied to the first terminal of the first capacitor C1, and the second terminal of the first capacitor C1 is connected to the first sampling transistor SMPX1. Electric charges may be accumulated in the first capacitor C1 according to the switching operation of the first sampling transistor SMPX1. For example, the electric charges according to the reset operation in which the floating diffusion node FD is reset may be accumulated in the first capacitor C1.

The first terminal of the second sampling transistor SMPX2 is connected to the first node N1, and the second terminal of the second sampling transistor SMPX2 is connected to the second capacitor C2. The second sampling transistor SMPX2 may be turned on or off in response to the second sampling control signal SMPS2 received from the row driver 12, and may connect the second capacitor C2 and the first node N1. For example, the second sampling control signal SMPS2 may be applied to a gate of the second sampling transistor SMPX2.

The pixel voltage VPIX is applied to the first terminal of the second capacitor C2, and the second terminal of the second capacitor C2 is connected to the second sampling transistor SMPX2. Electric charges may be accumulated in the second capacitor C2 according to the switching operation of the second sampling transistor SMPX2. For example, electric charges according to the photocharge accumulation operation in which photocharges generated by the photodiode PD are accumulated in the floating diffusion node FD may be accumulated in the second capacitor C2.

The pixel voltage VPIX is applied to the first terminal of the second source follower SF2, and the second terminal of the second source follower SF2 is connected to the selection transistor AX. The second source follower SF2 may amplify and output the signal according to a potential change at the first node N1. For example, the second source follower SF2 may amplify the pixel voltage VPIX.

The first terminal of the selection transistor AX is connected to the second source follower SF2, and the second terminal of the selection transistor AX is connected to a column line CL. The column line CL may be one of the first to n-th column lines CL0 to CLn-1 of FIG. 1. The selection transistor AX may be turned on or off in response to the selection control signal SELS received from the row driver 12. For example, the selection control signal SELS may be applied to a gate of the selection transistor AX. When the selection transistor AX is turned on, the reset signal RST corresponding to the reset operation may be output or the image signal SIG corresponding to the electric charge accumulation operation may be output to the column line CL. That is, the second source follower SF2 and the selection transistor AX may output the pixel signal PXS according to the potential change at the first node N1 to the column line CL, and may output the pixel signal PXS corresponding to either the amount of electric charges accumulated in the first capacitor C1 or the amount of electric charges accumulated in the second capacitors C2 through the column line CL.

The pixel PX of the image sensor 1000 according to an embodiment effectively resets the first node N1, by including the first pre-charge selection transistor PSX1 and the second pre-charge selection transistor PSX2. The image sensor 1000 may remove an offset that occurs between the reset signal RST according to the reset operation due to electric charges remaining at the first node N1 and the image signal SIG according to the electric charge accumulation operation.

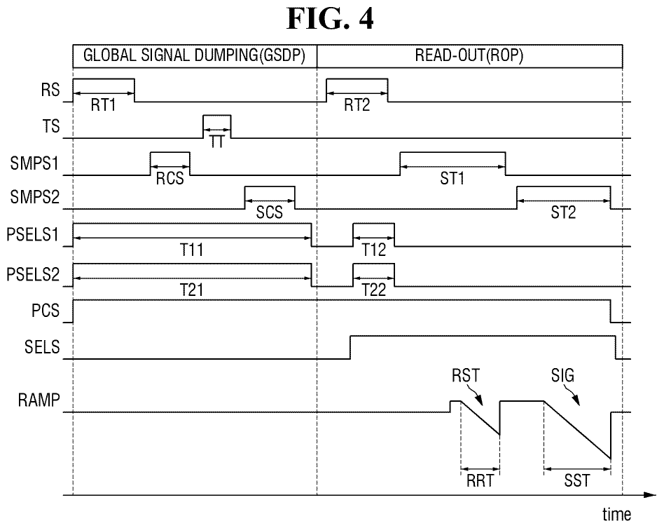

FIG. 4 is a timing diagram showing control signals and ramp signal provided to pixels of the image sensor according to an embodiment.

The same control signals may be applied to the pixels located in the same row. The control signals described in FIG. 4 may be applied to the pixel PX described in FIG. 3, and will be described with reference to FIGS. 1, 3, and 4 together for convenience of the following description.

Referring to FIG. 4, operations to be described below may be performed during a global signal dumping period (GSDP).

The reset control signal RS transitions from a second level (e.g., low level) to a first level (e.g., high level) and maintains the first level during the first reset time RT1. In the global signal dumping period (GSDP), the conversion gain control signal DCS may transition from the second level to the first level, and maintain the first level for a reset time that is substantially the same as the first reset time RT1. Since the reset transistor RX and the conversion gain transistor DCX are turned on by the reset control signal RS of high level and the conversion gain control signal DCS, the floating diffusion node FD may be reset (reset operation).

After the reset control signal RS transitions from the high level to the low level, the first sampling control signal SMPS1 transitions from the low level to the high level, and the first sampling control signal SMPS1 maintains the high level during a reset settling time RCS. Since the first sampling transistor SMPX1 is turned on by the first sampling control signal SMPS1 of the high level, the voltage of the reset floating diffusion node FD may be sampled to the first capacitor C1 connected to the first node N1.

After the first sampling control signal SMPS1 transitions from the high level to the low level, the transfer control signal TS transitions from the low level to the high level, and maintains the high level during an integration time TT. Since the transfer transistor TX is turned on by the transfer control signal TS of a high level, the photocharges generated by the photodiode PD may be accumulated (accumulation operation) in the floating diffusion node FD. For example, the voltage of the floating diffusion node FD may gradually decrease from the pixel voltage VPIX depending on the amount of accumulated electric charges.

After the transfer control signal TS transitions from the high level to the low level, the second sampling control signal SMPS2 transitions from the low level to the high level, and maintains the high level during the signal settling time SCS. Since the second sampling transistor SMPX2 is turned on by the second sampling control signal SMPS2 of a high level, the voltage of the floating diffusion node FD may be sampled to the second capacitor C2 connected to the first node N1.

The first pre-charge selection control signal PSELS1 and the second pre-charge selection control signal PSELS2 transition from the low level to the high level before the first sampling control signal SMPS1 transitions from the low level to the high level, and maintains the high level, until the second sampling control signal SMPS2 transitions from the high level to the low level. For example, the first pre-charge selection control signal PSELS1 may maintain the high level during a first time T11, and the second pre-charge selection control signal PSELS2 may maintain the high level during a first time T21.

In some embodiments, the first time T11 of the first pre-charge selection control signal PSELS1 and the first time T21 of the second pre-charge selection control signal PSELS2 may overlap each other. For example, the first time T11 of the first pre-charge selection control signal PSELS1 and the first time T21 of the second pre-charge selection control signal PSELS2 may coincide with each other, but embodiments are not limited thereto. Since the first pre-charge selection transistor PSELX1 and the second pre-charge selection transistor PSELX2 maintain the on-state, the voltage of the floating diffusion node FD may be sampled to the first capacitor C1 or the second capacitor C2 connected to the first node N1.

The pre-charge control signal PCS transitions from the low level to the high level before the first sampling control signal SMPS1 transitions from the low level to the high level, and the pre-charge control signal PCS maintains the high level, until after the second sampling control signal SMPS2 transitions from the high level to the low level. The pre-charge transistor PCX may be turned on by the pre-charge control signal PCS of a high level, and the first node N1 may be pre-charged.

In the global signal dumping period GSDP, the selection control signal SELS maintains the low level.

Operations to be described below may be performed in the readout period ROP. The pre-charge control signal PCS may maintain the high level in the readout period ROP.

The reset control signal RS maintains a high level during a second reset time RT2 after transitioning from a low level to a high level. When the reset control signal RS maintains the high level during the second reset time RT2 in the readout period ROP, the conversion gain control signal DCS may maintain a high level for a reset time substantially equal to the second reset time RT2. The floating diffusion node FD may be reset by turning on the reset transistor RX with the reset control signal RS of a high level and turning on the conversion gain transistor DCX with the conversion gain control signal DCS of a high level. For example, the voltage of the floating diffusion node FD may be reset to the pixel voltage VPIX.

Further, the first pre-charge selection control signal PSELS1 and the second pre-charge selection control signal PSELS2 transition from the low level to the high level, the first pre-charge selection control signal PSELS1 maintain the high level during a second time T12, and the second pre-charge selection control signal PSELS2 maintains the high level during a second time T22. At this time, the second reset time RT12, the second time T12 of the first pre-charge selection control signal PSELS1, and the second time T22 of the second pre-charge selection control signal PSELS2 may overlap each other.

The first node N1 may be reset by the reset control signal RS of a high level, the first pre-charge selection control signal PSELS1 of a high level, and the second pre-charge selection control signal PSELS2 of a high level. For example, the first node N1 may be reset to the pixel voltage VPIX. Therefore, after the global signal dumping period GSDP ends, the electric charges remaining at the first node N1 may be removed.

In some embodiments, the transfer control signal TS may maintain a low state during the second reset time RT2. Alternatively, in the readout period ROP, the transfer control signal TS may be a high level during the integration time, and the integration time may be included in the second reset time RT2 at which the reset control signal RS has a high level.

The reset control signal RS transitions from the high level to the low level, the first pre-charge selection control signal PSELS1 transitions from the high level to the low level, and the second pre-charge selection control signal PSELS2 transitions from the high level to the low level. Accordingly, when the node reset operation ends, the first sampling control signal SMPS1 transitions from the low level to the high level, and maintains the high level during the first settling time ST1. At this time, in the first settling time ST1 period at which the first sampling control signal SMPS1 maintains the high level, the selection signal SELS may be the high level, the selection transistor AX may be turned on, and the reset signal RST corresponding to the electric charges according to the reset operation sampled to the first capacitor C1 may be output through the column line CL.

After the selection transistor AX is turned on, the ramp signal RAMP may be generated to decrease (or increase) at a constant slope during a first time RRT. During the first time RRT at which the voltage level of the ramp signal RAMP changes constantly, the correlated double sampling circuit 16 may compare the ramp signal RAMP and the reset signal RST.

After the first settling time ST1 elapses and the first sampling control signal SMPS1 transitions from the high level to the low level, the second sampling control signal SMPS2 transitions from the low level to the high level, and maintains the high level during the second settling time ST2. At this time, at the second settling time ST2 period during which the second sampling control signal SMPS2 maintains the high level, the selection signal SELS may be the high level, the selection transistor AX is turned on, and an image signal SIG corresponding to the electric charges according to the accumulation operation sampled to the second capacitor C2 may be output through the column line CL.

After the selection transistor AX is turned on, the ramp signal RAMP may be generated to decrease (or increase) at a constant slope during the second time SST. During the second time SST at which the voltage level of the ramp signal RAMP changes constantly, the correlated double sampling circuit 16 may compare the ramp signal RAMP and the image signal SIG.

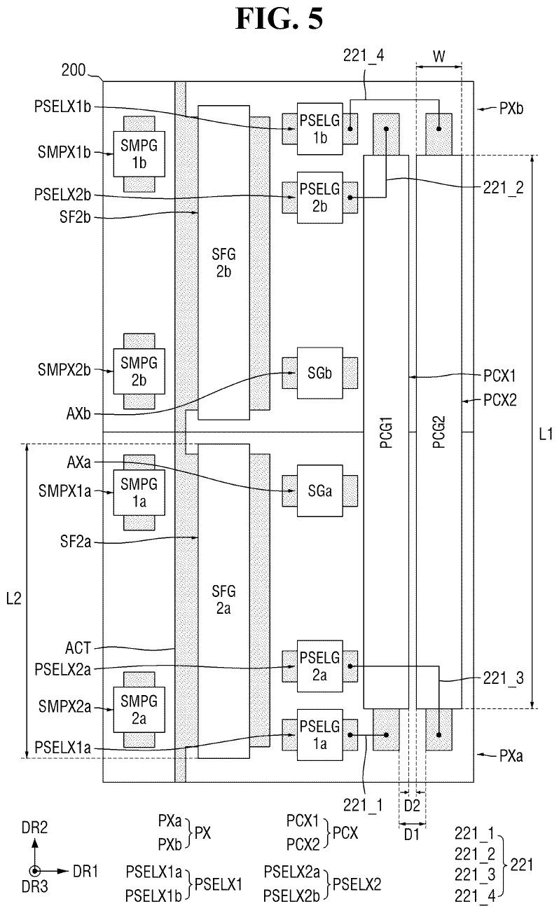

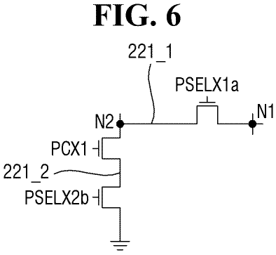

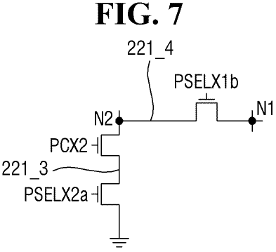

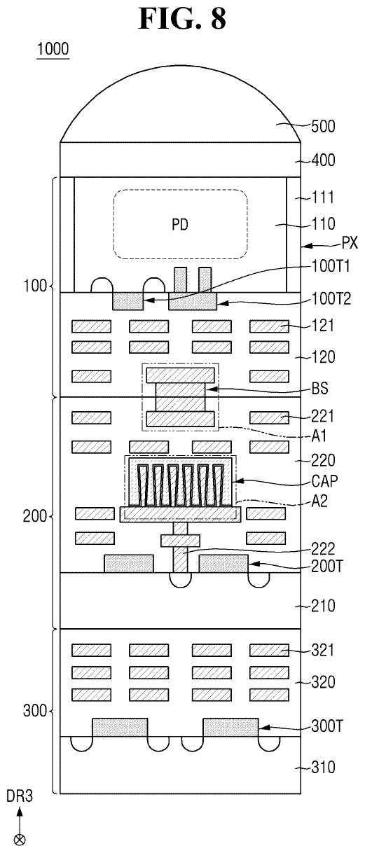

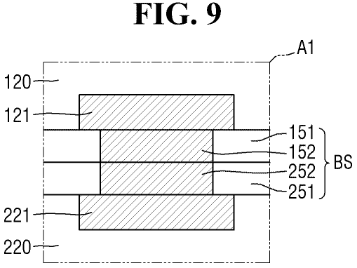

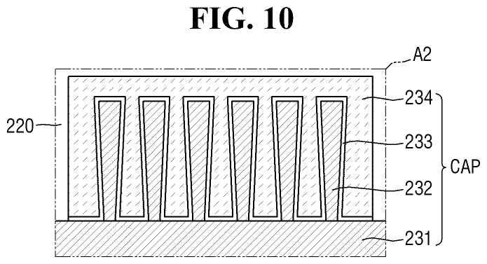

FIG. 5 is a layout diagram schematically showing a pixel region of an image sensor according to an embodiment. FIGS. 6 and 7 are diagrams for explaining the pre-charge transistor included in the circuit diagram of FIG. 3. FIG. 8 is a cross-sectional view schematically showing an image sensor according to some embodiments. FIGS. 9 and 10 are enlarged views of regions A1 and A2 of FIG. 8.

Referring to FIGS. 5 and 8, the image sensor according to an embodiment includes a first semiconductor chip 100, a second semiconductor chip 200, and a third semiconductor chip 300. The first to third semiconductor chips 100, 200, and 300 may be disposed to overlap each other from a planar viewpoint or in a plan view. The first to third semiconductor chips 100, 200, and 300 may be sequentially stacked.

From a planar viewpoint, each of the first to third semiconductor chips 100, 200, and 300 may extend in first and second directions DR1 and DR2 that intersect each other. The first and second directions DR1 and DR2 may refer to directions that intersect to be perpendicular to each other. The first to third semiconductor chips 100, 200, and 300 may be stacked in a third direction DR3 perpendicular to each of the first and second directions DR1 and DR2.

The first semiconductor chip 100 may be referred to as an upper plate, the second semiconductor chip 200 may be referred to as a middle plate, and the third semiconductor chip 300 may be referred to as a lower plate. In an embodiment, the above-described pixel part 100C is formed on the first semiconductor chip 100, and the circuit part 200C is formed on the second semiconductor chip 200.

In this case, the above-described photodiode PD, the transfer transistor TX, the reset transistor RX, the conversion gain transistor DCX, the floating diffusion node FD, and the first source follower SF1 may be formed on the first semiconductor chip 100. The first pre-charge selection transistor PSELX1, the second pre-charge selection transistor PSELX2, the pre-charge transistor PCX, the first sampling transistor SMPX1, the second sampling transistor SMPX2, the first capacitor C1, the second capacitor C2, the second source follower SF2, and the selection transistor AX may be formed on the second semiconductor chip 200.

A pixel PX of an image sensor according to an embodiment includes first and second pixel regions PXa and PXb. The first and second pixel regions PXa and PXb may be adjacent to each other in the second direction DR2.

The first pre-charge selection transistor PSELX1 includes first_1 and first_2 pre-charge selection transistor PSELX1a and PSELX1b disposed in each of the first and second pixel regions PXa and PXb. For example, PSELX1a of the first pre-charge selection transistor PSELX1 is disposed in the first pixel region PXa, while PSELX1b of the first pre-charge selection transistor PSELX1 is disposed in the second pixel region PXb. The second pre-charge selection transistor PSELX2 includes second_1 and second_2 pre-charge transistors PSELX2a and PSELX2b disposed in each of the first and second pixel regions PXa and PXb. For example, PSELX2a of the second pre-charge selection transistor PSELX2 is disposed in the first pixel region PXa, while PSELX2b of the second pre-charge selection transistor PSELX2 is disposed in the second pixel region PXb. The pre-charge transistor PCX includes first and second pre-charge transistors PCX1 and PCX2 disposed over the first and second pixel regions PXa and PXb.

In an embodiment, the first_1 pre-charge selection transistor PSELX1a, the second_1 pre-charge transistor PSELX2a, a part of the first and second pre-charge transistors PCX1 and PCX2, the first_1 sampling transistor SMPX1a, the first_2 sampling transistor SMPX2a, the second_1 source follower SF2a, and the first selection transistor AXa are disposed in the first pixel region PXa.

An active region ACT in which a gate and a source/drain that form each transistor are formed may be disposed in the first pixel region PXa. A gate PSELGla of the first_1 pre-charge selection transistor PSELX1a, a gate PSELG2a of the second_1 pre-charge transistor PSELX2a, gates PCG1 and PCG2 of each of the first and second pre-charge transistors PCX1 and PCX2, a gate SMPGla of the first_1 sampling transistor SMPX1a, a gate SMPG2a of the first_2 sampling transistor SMPX2a, a gate SFG2a of the second_1 source follower SF2a, and a gate SGa of the first selection transistor AXa may be disposed on the active region ACT of the first pixel region PXa.

In an embodiment, the first_2 pre-charge selection transistor PSELX1b, the second_2 pre-charge transistor PSELX2b, some of the first and second pre-charge transistors PCX1 and PCX2, the second_1 sampling transistor SMPX1b, the second_2 sampling transistor SMPX2b, the second_2 source follower SF2b, and the second selection transistor AXb are disposed in the second pixel region PXb.

An active region ACT in which a gate and source/drain that form each transistor are formed may be disposed in the second pixel region PXb. A gate PSELGlb of the first_2 pre-charge selection transistor PSELX1b, a gate PSELG2b of the second_2 pre-charge transistor PSELX2b, gates PCG1 and PCG2 of each of the first and second pre-charge transistors PCX1 and PCX2, a gate SMPGlb of the second_1 sampling transistor SMPX1b, a gate SMPG2b of the second_2 sampling transistor SMPX2b, a gate SFG2b of the second_2 source follower SF2b, and a gate SGb of the second selection transistor AXb may be disposed on the active region ACT of the second pixel region PXb.

From the planar viewpoint, the first and second pixel regions PXa and PXb may share the pre-charge transistor PCX. From the planar viewpoint, the pre-charge transistor PCX may extend in the second direction DR2 over the first and second pixel regions PXa and PXb that are adjacent to each other in the second direction DR2. From the planar viewpoint, a plurality of pre-charge transistors PCX spaced apart from each other in the first direction DR1 may be formed.

Although FIG. 5 only shows that the pre-charge transistor PCX being formed by two first and second pre-charge transistors PCX1 and PCX2 that are spaced apart from each other, embodiments are not limited thereto. For example, three or more pre-charge transistors PCX may be spaced apart from each other in other embodiments.

From the planar viewpoint, the respective active regions ACT in which the first and second pre-charge transistors PCX1 and PCX2 spaced apart from each other are formed may be spaced apart from each other in the first direction DR1. In an embodiment, a spaced distance D1 of the respective active regions ACT is greater than a spaced distance D2 of the respective gates PCG1 and PCG2 of the first and second pre-charge transistors PCX1 and PCX2 on the basis of the first direction DR1.

In an embodiment, from the planar viewpoint, on the basis of the second direction DR2, an extension length L1 of the gates PCG1 and PCG2 of the pre-charge transistor PCX is longer than an extension length L2 of the gate SFG2a of the second_1 source follower SF2a. Further, on the basis of the second direction DR2, the extension length L1 of each of the gates PCG1 and PCG2 of the pre-charge transistor PCX may be longer than the extension length of the gate SFG2b of the second_1 source follower SF2b.

The first pre-charge selection transistor PSELX1 and the second pre-charge selection transistor PSELX2 connected to the pre-charge transistor PCX may be disposed in different pixel regions from each other.

Referring to FIGS. 5 and 6, the first pre-charge transistor PCX1 may be connected to the first_1 pre-charge selection transistor PSELX1a of the first pixel region PXa and the second_2 pre-charge selection transistor PSELX2b of the second pixel region PXb.

In an embodiment, the first pre-charge transistor PCX1 is electrically connected to the first_1 pre-charge selection transistor PSELX1a of the first pixel region PXa through a first conductive line 221_1, and is electrically connected to the second_2 pre-charge selection transistor PSELX2b of the second pixel region PXb through a second conductive line 221_2.

The first conductive line 221_1 may electrically connect the source/drain region of the first_1 pre-charge selection transistor PSELX1a and the source/drain region of the first pre-charge transistor PCX1. The second conductive line 221_2 may electrically connect the source/drain region of the second_2 pre-charge selection transistor PSELX2b and the source/drain region of the first pre-charge transistor PCX1. For example, the first conductive line 221_1 could be connected to a source region of the first pre-charge transistor PCX1 and the second conductive line 221_2 could be connected to a drain region of the first pre-charge transistor PCX1, or vice versa.

Referring to FIGS. 5 and 7, the second pre-charge transistor PCX2 may be connected to the second_1 pre-charge selection transistor PSELX2a of the first pixel region PXa and the first_2 pre-charge selection transistor PSELX1b of the second pixel region PXb.

In an embodiment, the second pre-charge transistor PCX1 is electrically connected to the second_1 pre-charge selection transistor PSELX2a of the first pixel region PXa through a third conductive line 221_3, and is electrically connected to the first_2 pre-charge selection transistor PSELX1b of the second pixel region PXb through a fourth conductive line 221_4.

The third conductive line 221_3 may electrically connect the source/drain region of the second_1 pre-charge selection transistor PSELX2a and the source/drain region of the second pre-charge transistor PCX2. The fourth conductive line 221_4 may electrically connect the source/drain region of the first_2 pre-charge selection transistor PSELX1b and the source/drain region of the second pre-charge transistor PCX2. For example, the third conductive line 221_3 could be connected to a source region of the second pre-charge transistor PCX2 and the fourth conductive line 221_4 could be connected to a drain region of the second pre-charge transistor PCX2, or vice versa.

The first to fourth conductive lines 221_1, 221_2, 221_3, and 221_4 may be included in a second wiring layer 221, which will be described below.

The pre-charge transistor PCX may have a relatively large size to operate as a current source. For example, a gate width or a gate thickness of the pre-charge transistor PCX may be relatively large. As a result, since the capacitance of the pre-charge transistor PCX also increases, a large amount of power may be consumed to turn on/off the pre-charge transistor PCX. That is, when the nodes N1 and N2 are reset by the turning-on/off operation of the pre-charge transistor PCX, a relatively large amount of power may be consumed.

According to an embodiment, the pre-charge transistor PCX is disposed on the second semiconductor chip 200 such that the pre-charge transistor PCX is shared between the adjacent pixel regions. Accordingly, a ratio of the length W in the first direction DR1 to the length L1 in the second direction DR2 of the pre-charge transistor PCX may be lowered to reduce Transconductance (e.g., see gₘ of Equation 1 below). Referring to Equation 1 below, transconductance (gₘ) may be expressed through an amount of change in current (∂ID) between source and drain in comparison to amount of change in voltage (∂Vgs) between gate and source.

$${g}_{m} = \frac{\partial {I}_{D}}{\partial {V}_{GS}} \qquad [ Equation 1 ]$$

For example, the ratio of the length (W of FIG. 5) in the first direction DR1 to the length (L1 of FIG. 5) in the second direction DR2 of the pre-charge transistor PCX according to some embodiments may decrease by about ¼ times, compared to a case where the pre-charge transistor PCX is located in only one pixel region. As a result, current may be supplied more consistently by reducing the amount of current change depending on the voltage change.

Referring to FIG. 8, the first semiconductor chip 100 and the second semiconductor chip 200 of the image sensor 1000 according to some embodiments may be bonded by a bonding structure BS.

Although one bonding structure BS is shown in FIG. 8, the present disclosure is not limited thereto, and a plurality of bonding structures BS may be formed.

The first semiconductor chip 100 may include a first substrate 110 including a pixel PX, a first insulating layer 120, and a first wiring layer 121.

The pixel PX may include a photodiode PD that converts light incident from outside into an electrical signal, and a gate of the first_2 transistor 100T2 included in the pixel circuit. For example, the gate of the first_2 transistor 100T2 may have a vertical structure in which at least a partial region is embedded in the first substrate 110. However, this is just an example as the technical idea of the present disclosure is not limited thereto.

A pixel isolation pattern 111 may be formed in the first substrate 110. The pixel isolation pattern 111 may be formed by embedding an insulating material inside a deep trench formed by patterning the first substrate 110. The pixel isolation pattern 111 may penetrate the first substrate 110 in the third direction DR3. For example, the pixel isolation pattern 120 may be, but is not limited to, a front deep trench isolation (FDTI).

The pixel isolation pattern 111 may define a plurality of pixels PX. The pixel isolation pattern 111 may be formed in a lattice shape from a planar viewpoint, and separate the plurality of pixels PX from each other.

The first insulating layer 120 may be disposed on the first substrate 110. The first insulating layer 120 may include a first_2 transistor 100T2 formed in a region adjacent to the first substrate 110. The first_2 transistor 100T2 formed in the first insulating layer 120 may be a transfer transistor. The first_1 transistor 100T1 formed in the first insulating layer 120 may be, but is not limited to, one of a reset transistor, a conversion gain transistor, and a source follower, other than the transfer transistor.

The first wiring layer 121 may be formed in the first insulating layer 120. The first wiring layer 121 may be electrically connected to the second semiconductor chip 200.

A circuit electrically connected to the pixel PX may be formed on the second semiconductor chip 200. The second semiconductor chip 200 may include a second substrate 210, a second insulating layer 220, and a second wiring layer 221.

For example, the circuit formed on the second substrate 210 may be a circuit including a plurality of transistors 200T for performing the global shutter operation.

The plurality of transistors 200T formed on the second substrate 210 may implement the global shutter operation together with the capacitor structure CAP included in the second wiring layer 221. For example, the plurality of transistors 200T and the capacitor structure CAP may operate to simultaneously expose all pixels on the image sensor 1000 to light and perform a readout operation on a row-by-row basis. The plurality of transistors 200T formed on the second substrate 210 may be, but is not limited to, a pre-charge transistor PCX.

According to some embodiments, the degree of integration may be increased by disposing the pre-charge transistor PCX to be shared with an adjacent pixel region, in the second semiconductor chip 200 on which the pixel isolation pattern 111 is not disposed.

The second wiring layer 221 may be formed inside the second insulating layer 220. The second wiring layer 221 may electrically connect the first semiconductor chip 100 and the second semiconductor chip 200, and the second semiconductor chip 200 and the third semiconductor chip 300.

Referring to FIG. 9, the bonding structure BS may include a first bonding metal 152, a first bonding insulating layer 151, a second bonding metal 252, and a second bonding insulating layer 251.

By disposing the first bonding metal 152 at the bottom of the first semiconductor chip 100 into direct contact with the second bonding metal 252 at the top of the second semiconductor chip 200, the first and second semiconductor chips 100 and 200 may be bonded to face each other.

In an embodiment, the first bonding metal 152 and the second bonding metal 252 include copper (Cu). In other words, the bonding structure BS may be a bonding structure made up of Cu—Cu bonding.

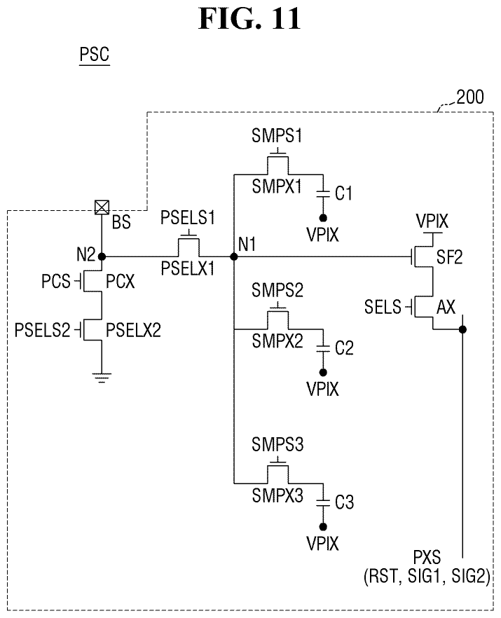

As shown in FIG. 10, the capacitor structure CAP may include a lower electrode 231, a conductive filler 232, an insulating film 233, and an upper electrode 234. The capacitor structure CAP may include first and second capacitors C1 and C2 shown in FIG. 3 and/or a third capacitor C3 shown in FIG. 11, which will be described below. Although the capacitor structure CAP is shown to have a filler shape, the shape is not limited thereto. For example, the capacitor structure CAP may be formed in a cylindrical shape.

For example, each of the lower electrode 231 and the upper electrode 234 may include a metal material. The insulating film 233 may include a dielectric material.

The capacitor structure CAP may be electrically connected to the sources/drains of the plurality of transistors 200T through the contact 222. The contact 222 may be a conductor.

The third semiconductor chip 300 may include a third substrate 310 on which the peripheral circuit element 300T is formed, a third insulating layer 320 on the third substrate 310, and a third wiring layer 321 in the third insulating layer 320. For example, a logic circuit of the image sensor 1000 may be formed on the third substrate 310. The peripheral circuit formed on the third substrate 310 may include a plurality of transistors 300T. The plurality of transistors 300T may implement a logic circuit including the controller 12, the ramp signal generator 13, the row driver 14, and the readout circuit 15 of the image sensor 1000 shown in FIG. 1.

The color filter 400 may be arranged to correspond to each pixel region PX. For example, the plurality of color filters 400 may be arranged two-dimensionally (e.g., in the form of a matrix).

The color filter 400 may have various color filters depending on the pixel PX. For example, the color filters 400 may be disposed in a Bayer pattern including a red color filter, a green color filter, and a blue color filter. However, this is only exemplary, and the color filter 400 may include a yellow filter, a magenta filter, and a cyan filter, and may further include a white filter.

A microlens 500 may be formed on the color filter 400. The microlens 500 may be arranged to correspond to each pixel PX. For example, the microlenses 500 may be arranged two-dimensionally (e.g., in a matrix form) in a plane.

The microlens 500 has a convex shape, and may have a predetermined radius of curvature. Accordingly, the microlens 500 may condense light that enters the photodiode PD. The microlens 500 may include, for example but not limited to, a light-transmitting resin.

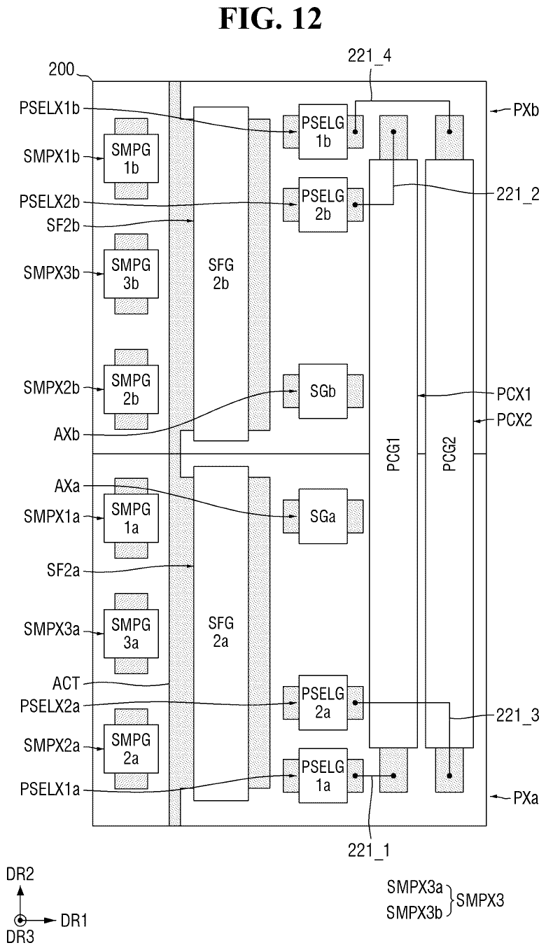

FIG. 11 is a circuit diagram of a pixel included in an image sensor according to an embodiments. FIG. 12 is a layout diagram schematically showing a pixel region of an image sensor according to an embodiments. For convenience of explanation, points that are different from those described using FIGS. 1 to 10 will be mainly explained.

The control signals TS, RS, DCS, PSELS1, PSELS2, PCS, SMPS1, SMPS2, SMPS3, and SELS applied to the pixel signal generation circuit PSC may be some of the control signals CSs generated by the row driver 12.

Referring to FIG. 11, the circuit part 200C may further include a third capacitor C3 and a third sampling transistor SMPX3. The third capacitor C3 is connected to the first node N1. A first terminal of the third sampling transistor SMPX3 is connected to the first node N1, and a second terminal is connected to the third capacitor C3. The third sampling transistor SMPX3 may sample electric charges to the third capacitor C3.

Referring to FIG. 12, the third sampling transistor SMPX3 includes third_1 and third_2 sampling transistors SMPX3a and SMPX3b disposed in each of the first and second pixel regions PXa and PXb. For example, SMPX3a of the third sampling transistor SMPX3 may be disposed in the first pixel region PXa, while SMPX3b of the third sampling transistor SMPX3 may be disposed in the second pixel region PXb. Each of the third_1 and third_2 sampling transistors SMPX3a and SMPX3b may include gates SMPG3a and SMPG3b formed on the active region ACT.

On the basis of the second direction DR2, the third_1 sampling transistor SMPX3a may be disposed between the first_1 sampling transistor SMPX1a and the first_2 sampling transistor SMPX2a. On the basis of the second direction DR2, the third_2 sampling transistor SMPX3b may be disposed between the second_1 sampling transistor SMPX1b and the second_2 sampling transistor SMPX2b. However, the placement relation of the third sampling transistor SMPX3 is not limited thereto.

Electric charges caused by the reset operation that resets the floating diffusion node FD may be accumulated in the first capacitor C1 (reset operation). First and second image signals SIG1 and SIG2 may be provided from the object to the image sensor through the microlens 500. Electric charges due to the first image signal SIG1 may be accumulated in the second capacitor C2 (first accumulation operation), and charges corresponding to the second image signal SIG2 may be accumulated in the third capacitor C3 (second accumulation operation).

In some embodiments, the first and second pixel regions PXa and PXb may operate as Auto Focus (AF) pixels. In this case, the AF operation may be performed using the reset signal RST, the first image signal SIG1, and the second image signal SIG2 obtained by performing the reset operation, the first accumulation operation, and the second accumulation operation.

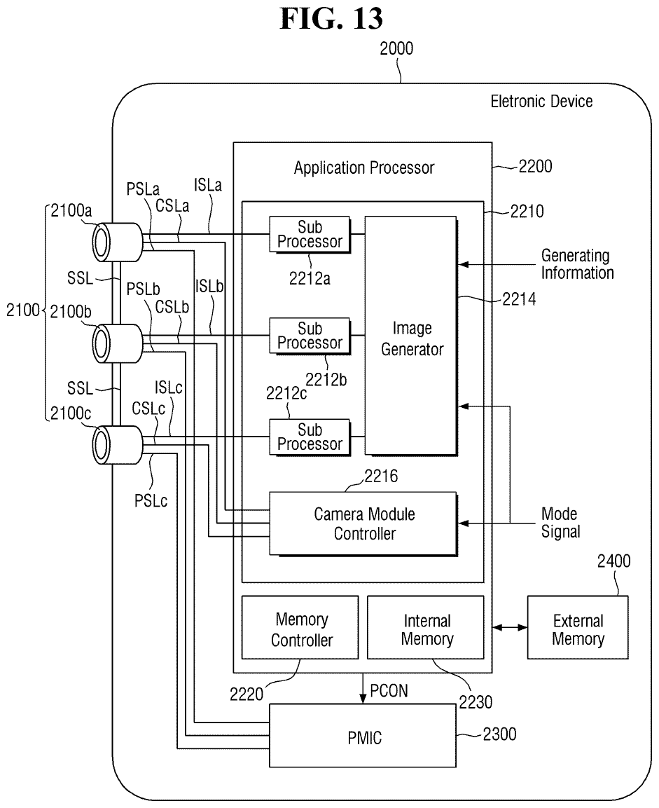

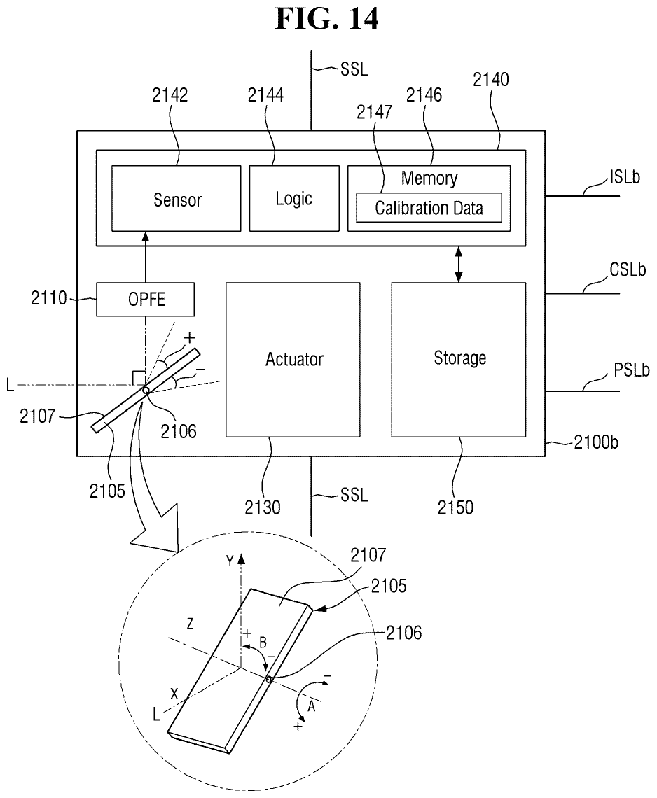

Hereinafter, an electronic device 2000 according to an embodiment will be described referring to FIGS. 13 and 14.

FIGS. 13 and 14 are block diagrams for explaining an electronic device including the image sensor according to some embodiments. For convenience of explanation, repeated parts of contents explained using FIGS. 1 to 12 will be briefly explained or omitted.

Referring to FIG. 13, the electronic device 2000 may include a camera module group 2100, an application processor 2200, a PMIC 2300, an external memory 2400.

The camera module group 2100 may include a plurality of camera modules 2100a, 2100b, and 2100c. Even if the drawing shows an embodiment in which the three camera modules 2100a, 2100b, and 2100c are placed, the embodiments are not limited thereto. In some embodiments, the camera module group 2100 may be modified to include only two camera modules. Also, in some embodiments, the camera module group 2100 may be modified to include n (n is a natural number equal to or greater than 4) camera modules.

Hereinafter, although a detailed configuration of the camera module 2100b will be described in more detail referring to FIG. 14, the following description may also be equally applied to other camera modules 2100a and 2100c depending on the embodiments.

Referring to FIG. 14, the camera module 2100b may include a prism 2105, an optical path folding element (hereinafter, “OPFE”) 2110, an actuator 2130, an image sensing device 2140, and a storage unit 2150.

The prism 2105 may include a reflecting surface 2107 of a light-reflecting material to change the path of light L that is incident from the outside.

In some embodiments, the prism 2105 may change the path of light L incident in the first direction X to a second direction Y perpendicular to the first direction X. Further, the prism 2105 may rotate the reflecting surface 2107 of the light-reflecting material in a direction A around a central axis 2106 or rotate the central axis 2106 in a direction B to change the path of the light L incident in the first direction X into the vertical second direction Y. At this time, the OPFE 2110 may also move in a third direction Z that is perpendicular to the first direction X and the second direction Y.

In some embodiments, as shown, although a maximum rotation angle of the prism 2105 in the direction A is equal to or less than 15 degrees in a positive (+) direction A, and may be greater than 15 degrees in a negative (−) direction A, the embodiments are not limited thereto.

In some embodiments, the prism 2105 may move about 20 degrees, or between 10 and 20 degrees, or between 15 and 20 degrees in the positive (+) or negative (−) direction B. Here, a moving angle may move at the same angle in the positive (+) or negative (−) direction B, or may move to almost the same angle within the range of about 1 degree.

In some embodiments, the prism 2105 may move the reflecting surface 2107 of the light-reflecting material in the third direction (e.g., a direction Z) parallel to an extension direction of the central axis 2106.

The OPFE 2110 may include, for example, an optical lens made up of m (here, m is a natural number) groups. The m lenses may move in the second direction Y to change an optical zoom ratio of the camera module 2100b. For example, when a basic optical zoom ratio of the camera module 2100b is set as Z, if the m optical lenses included in the OPFE 2110 are moved, the optical zoom ratio of the camera module 2100b may be changed to the optical zoom ratio of 3Z or 5Z or higher.

The actuator 2130 may move the OPFE 2110 or an optical lens (hereinafter, referred to as an optical lens) to a specific position. For example, the actuator 2130 may adjust the position of the optical lens so that an image sensor 2142 is located at a focal length of the optical lens for accurate sensing.

The image sensing device 2140 may include an image sensor 2142, a control logic 2144, and a memory 2146. The image sensor 2142 may sense an image to be sensed, using light L provided through the optical lens. In some embodiments, the image sensor 2142 may include the image sensor 1000 described above.

The control logic 2144 may control the overall operation of the camera module 2100b. For example, the control logic 2144 may control the operation of the camera module 2100b in accordance with the control signal provided through the control signal line CSLb.

The memory 2146 may store information necessary for the operation of the camera module 2100b such as calibration data 2147. The calibration data 2147 may include information necessary for the camera module 2100b to generate image data, using the light L provided from the outside. The calibration data 2147 may include, for example, information on the degree of rotation, information on the focal length, information on the optical axis explained above, and the like. When the camera module 2100b is implemented in the form of a multi-state camera whose focal length changes depending on the position of the optical lens, the calibration data 2147 may include information about the focal length values for each position (or for each state) of the optical lens and auto focusing.

The storage unit 2150 may store the image data sensed through the image sensor 2142. The storage unit 2150 may be placed outside the image sensing device 2140, and may be implemented in the form of being stacked with sensor chips constituting the image sensing device 2140. In some embodiments, although the storage unit 2150 may be implemented as an EEPROM (Electrically Erasable Programmable Read-Only Memory), the embodiments are not limited thereto.

Referring to FIGS. 13 and 14 together, in some embodiments, each of the plurality of camera modules 2100a, 2100b, and 2100c may include an actuator 2130. Accordingly, each of the plurality of camera modules 2100a, 2100b, and 2100c may include calibration data 2147 that is the same as or different from each other according to the operation of the actuator 2130 included therein.

In some embodiments, one camera module (e.g., 2100b) among the plurality of camera modules 2100a, 2100b, and 2100c may be a folded lens type camera module including the prism 2105 and the OPFE 2110 described above, and the remaining camera modules (e.g., 2100a and 2100c) may be vertical camera modules which do not include the prism 2105 and the OPFE 2110. However, the embodiments are not limited thereto.

In some embodiments, one camera module (e.g., 2100c) among the plurality of camera modules 2100a, 2100b, and 2100c may be a vertical depth camera which extracts depth information, for example, using an IR (Infrared Ray). In this case, the application processor 2200 may merge the image data provided from such a depth camera with the image data provided from another camera module (e.g., 2100a or 2100b) to generate a three-dimensional (3D) depth image.

In some embodiments, at least two camera modules (e.g., 2100a and 2100c) among the plurality of camera modules 2100a, 2100b, and 2100c may have fields of view different from each other. In this case, for example, although the optical lenses of at least two camera modules (e.g., 2100a and 2100c) among the plurality of camera modules 2100a, 2100b, and 2100c may be different from each other, the embodiments are not limited thereto.

Also, in some embodiments, viewing angles of each of the plurality of camera modules 2100a, 2100b, and 2100c may be different from each other. In this case, although the optical lenses included in each of the plurality of camera modules 2100a, 2100b, and 2100c may also be different from each other, the embodiments are not limited thereto.

In some embodiments, each of the plurality of camera modules 2100a, 2100b, and 2100c may be placed to be physically separated from each other. That is, a sensing region of one image sensor 2142 is not used separately by the plurality of camera modules 2100a, 2100b, and 2100c, but the independent image sensor 2142 may be placed inside each of the plurality of camera modules 2100a, 2100b, and 2100c.

Referring to FIG. 13 again, the application processor 2200 may include an image processing device 2210, a memory controller 2220, and an internal memory 2230. The application processor 2200 may be implemented separately from the plurality of camera modules 2100a, 2100b, and 2100c. For example, the application processor 2200 and the plurality of camera modules 2100a, 2100b, and 2100c may be implemented separately as separate semiconductor chips.

The image processing device 2210 may include a plurality of sub-image processors 2212a, 2212b, and 2212c, an image generator 2214, and a camera module controller 2216.

The image processing device 2210 may include a plurality of sub-image processors 2212a, 2212b, and 2212c corresponding to the number of the plurality of camera modules 2100a, 2100b, and 2100c.

Image data generated from each of the camera modules 2100a, 2100b, and 2100c may be provided to the corresponding sub-image processors 2212a, 2212b, and 2212c through image signal lines ISLa, ISLb, and ISLc separated from each other. For example, the image data generated from the camera module 2100a may be provided to the sub-image processor 2212a through an image signal line ISLa, the image data generated from the camera module 2100b may be provided to the sub-image processor 2212b through an image signal line ISLb, and the image data generated from the camera module 2100c may be provided to the sub-image processor 2212c through an image signal line ISLc. Although such an image data transmission may be performed using, for example, a camera serial interface (CSI) based on a mobile industry processor interface (MIPI), the embodiments are not limited thereto.

On the other hand, in some embodiments, a single sub-image processor may be arranged to correspond to a plurality of camera modules. For example, the sub-image processor 2212a and the sub-image processor 2212c is not implemented separately from each other as shown, but may be implemented by being integrated as a single sub-image processor. The image data provided from the camera module 2100a and the camera module 2100c may be selected through a selection element (e.g., a multiplexer) or the like, and then provided to an integrated sub-image processor.

The image data provided to the respective sub-image processors 2212a, 2212b, and 2212c may be provided to the image generator 2214. The image generator 2214 may generate the output image, using the image data provided from the respective sub-image processors 2212a, 2212b, and 2212c according to the image generating information or the mode signal.

Specifically, the image generator 2214 may merge at least some of the image data generated from the camera modules 2100a, 2100b, and 2100c having different viewing angles to generate the output image, in accordance with the image generating information or the mode signal. Further, the image generator 2214 may select any one of the image data generated from the camera modules 2100a, 2100b, and 2100c having different viewing angles to generate the output image, in accordance with the image generating information or the mode signal.

In some embodiments, the image generating information may include a zoom signal (or a zoom factor). Also, in some embodiments, the mode signal may be, for example, a signal based on the mode selected from a user.

When the image generating information is a zoom signal (a zoom factor) and each of the camera modules 2100a, 2100b, and 2100c has fields of view (viewing angles) different from each other, the image generator 2214 may perform different operations depending on the type of zoom signals. For example, when the zoom signal is a first signal, the image data output from the camera module 2100a and the image data output from the camera module 2100c are merged, and then, an output image may be generated, using the merged image signal and the image data which is not used for merging and output from the camera module 2100b. If the zoom signal is a second signal that is different from the first signal, the image generator 2214 does not merge the image data, and may select any one of the image data output from each of the camera modules 2100a, 2100b, and 2100c to generate the output image. However, the embodiments are not limited thereto, and a method of processing the image data may be modified as much as necessary.

In some embodiments, the image generator 2214 may receive a plurality of image data with different exposure times from at least one of the plurality of sub-image processors 2212a, 2212b and 2212c, and perform a high dynamic range (HDR) process on the plurality of image data to generate merged image data with an increased dynamic range.

The camera module controller 2216 may provide the control signal to each of the camera modules 2100a, 2100b, and 2100c. The control signals generated from the camera module controller 2216 may be provided to the corresponding camera modules 2100a, 2100b, and 2100c through the control signal lines CSLa, CSLb and CSLc separated from each other.

Any one of the plurality of camera modules 2100a, 2100b, and 2100c may be designated as a master camera (e.g., 2100a) depending on the image generating information including the zoom signal or the mode signal, and the remaining camera modules (e.g., 2100b and 2100c) may be designated as slave cameras. Such information is included in the control signal, and may be provided to the corresponding camera modules 2100a, 2100b, and 2100c through the control signal lines CSLa, CSLb and CSLc separated from each other.

The camera modules that operate as master and slave may be changed depending on the zoom factor or the operating mode signal. For example, if the viewing angle of the camera module 2100a is wider than that of the camera module 2100c and the zoom factor exhibits a low zoom ratio, the camera module 2100c may operate as the master, and the camera module 2100a may operate as the slave. In contrast, when the zoom factor exhibits a high zoom ratio, the camera module 2100a may operate as the master, and the camera module 2100c may operate as the slave.

In some embodiments, the control signals provided from the camera module controller 2216 to the respective camera modules 2100a, 2100b, and 2100c may include a sync enable signal. For example, if the camera module 2100b is the master camera and the camera modules 2100a and 2100c are the slave cameras, the camera module controller 2216 may transmit the sync enable signal to the camera module 2100b. The camera module 2100b, which is provided with the sync enable signal, may generate a sync signal on the basis of the provided sync enable signal, and may provide the generated sync signal to the camera modules 2100a and 2100c through the sync signal line SSL. The camera module 2100b and the camera modules 2100a and 2100c may transmit the image data to the application processor 2200 in synchronization with such a sync signal.

In some embodiments, the control signals provided from the camera module controller 2216 to the plurality of camera modules 2100a, 2100b, and 2100c may include mode information according to the mode signal. On the basis of the mode information, the plurality of camera modules 2100a, 2100b, and 2100c may operate in a first operating mode and a second operating mode in connection with the sensing speed.

The plurality of camera modules 2100a, 2100b, and 2100c may generate an image signal at a first speed in the first operating mode (for example, generate an image signal of a first frame rate), encode the image signal at a second speed higher than the first speed (for example, encode an image signal of a second frame rate higher than the first frame rate), and transmit the encoded image signal to the application processor 2200. For example, the second speed may be 30 times or less of the first speed.

The application processor 2200 may store the received image signal, that is to say, the encoded image signal, in the memory 2230 disposed inside or an external storage 2400 of the application processor 2200, and then read and decode the encoded image signal from the memory 2230 or the storage 2400, and display image data generated on the basis of the decoded image signal. For example, the corresponding sub-processors among the plurality of sub-processors 2212a, 2212b, and 2212c of the image processing device 2210 may perform decoding, and may also perform the image processing on the decoded image signal. For example, the image data generated on the basis of the decoded image signal may be displayed on a display.

A plurality of camera modules 2100a, 2100b, and 2100c may generate image signals at a third speed lower than the first speed in the second operating mode (for example, generate an image signal of a third frame rate lower than the first frame rate), and transmit the image signal to the application processor 2200. The image signal provided to the application processor 2200 may be a non-encoded signal. The application processor 2200 may perform the image processing on the received image signal or store the image signal in the memory 2230 or the storage 2400.

The PMIC 2300 may supply a power, e.g., a power supply voltage, to each of the plurality of camera modules 2100a, 2100b, and 2100c. For example, the PMIC 2300 may supply a first power to the camera module 2100a through a power signal line PSLa, supply a second power to the camera module 2100b through a power signal line PSLb, and supply a third power to the camera module 2100c through a power signal line PSLc, under the control of the application processor 2200.

The PMIC 2300 may generate power corresponding to each of the plurality of camera modules 2100a, 2100b, and 2100c and adjust the level of power, in response to a power control signal PCON from the application processor 2200. The power control signal PCON may include power adjustment signals for each operating mode of the plurality of camera modules 2100a, 2100b, and 2100c. For example, the operating mode may include a low power mode, and at this time, the power control signal PCON may include information about the camera module that operates in the low power mode and a power level to be set. The levels of powers provided to each of the plurality of camera modules 2100a, 2100b, and 2100c may be the same as or different from each other. Also, the levels of the powers may be changed dynamically.

Although embodiments of the present disclosure have been described above with reference to the accompanying drawings, the present disclosure is not limited to the above embodiments, and may be implemented in various different forms. Those skilled in the art will appreciate that the present disclosure may be embodied in other specific forms without changing the technical spirit of the present disclosure. Accordingly, the above-described embodiments should be understood in all respects as illustrative and not restrictive.

What is claimed is:

1. An image sensor comprising:
a first semiconductor chip which extends in first and second directions that intersect each other, and includes a pixel part comprising a plurality of pixel regions; and
a second semiconductor chip comprising a circuit part electrically connected to the pixel part, on the first semiconductor chip,
wherein the pixel part comprises:
a photodiode,
a floating diffusion node which accumulates photocharges generated by the photodiode, and
a first source follower which amplifies and outputs a signal corresponding to a change in potential of the floating diffusion node,
wherein the circuit part comprises:
a first pre-charge selection transistor connected between a first node and a second node,
a second pre-charge selection transistor connected to the first pre-charge selection transistor, and
a pre-charge transistor to pre-charge the second node connected to the first source follower,
wherein the plurality of pixel regions share the pre-charge transistor.

2. The image sensor of claim 1,
wherein the pre-charge transistor extends in the first direction over the plurality of pixel regions adjacent to each other in the first direction, in a planar viewpoint.

3. The image sensor of claim 1, further comprising
a plurality of pre-charge transistors spaced apart from each other in the second direction in a planar viewpoint to include the pre-charge transistor.

4. The image sensor of claim 3,
wherein first and second active regions in which the plurality of pre-charge transistors spaced apart are each formed are arranged to be spaced apart from each other in the second direction, in the planar viewpoint.

5. The image sensor of claim 1,
wherein the first pre-charge selection transistor and the second pre-charge selection transistor connected to the pre-charge transistor are disposed in different pixel regions from each other.

6. The image sensor of claim 1,
wherein the circuit part further comprises a second source follower that amplifies and outputs a signal corresponding to a change in potential of the first node, and
an extension length of the pre-charge transistor is longer than an extension length of the second source follower, on the basis of the first direction.

7. The image sensor of claim 1,
wherein the circuit part further comprises:
a first capacitor connected to the first node, and a first sampling transistor that samples electric charges to the first capacitor; and
a second capacitor connected to the first node, and a second sampling transistor that samples electric charges to the second capacitor.

8. The image sensor of claim 7,
wherein the first capacitor stores electric charges according to a voltage of the floating diffusion node being reset, and
the second capacitor stores electric charges according to the voltage of the floating diffusion node in which the photocharges are accumulated.

9. The image sensor of claim 7,
wherein the circuit part further comprises:
a third capacitor connected to the first node, and a third sampling transistor that samples electric charges to the third capacitor.

10. The image sensor of claim 1, further comprising:
a bonding structure which bonds a first bonding metal of a bottom of the first semiconductor chip and a second bonding metal of a top of the second semiconductor chip.

11. The image sensor of claim 1, further comprising:
a transfer transistor, a reset transistor, and a conversion gain transistor disposed on the first semiconductor chip; and
a selection transistor disposed on the second semiconductor chip.

12. An image sensor comprising:
a first semiconductor chip including a pixel part comprising first and second pixel regions that are adjacent to one other; and
a second semiconductor chip including a circuit part for performing a global shutter operation, on the first semiconductor chip,
wherein the pixel part comprises:
a photodiode,
a floating diffusion node which accumulates photocharges generated by the photodiode, and
a first source follower which amplifies and outputs a signal corresponding to a change in potential of the floating diffusion node,
wherein the circuit part comprises:
a first pre-charge selection transistor connected between a first node and a second node,
a second pre-charge selection transistor connected to the first pre-charge selection transistor, and
a pre-charge transistor to pre-charge the second node connected to the first source follower,
wherein the pre-charge transistor comprises:
a first pre-charge transistor connected to a first_1 pre-charge selection transistor of the first pixel region and a second_1 pre-charge selection transistor of the second pixel region, and
a second pre-charge transistor connected to a second_2 pre-charge selection transistor of the first pixel region and a first_2 pre-charge selection transistor of the second pixel region.

13. The image sensor of claim 12,
wherein the first and second pre-charge transistors are disposed over the first and second pixel regions inside the second semiconductor chip.

14. The image sensor of claim 12,
wherein the first and second pre-charge transistors are spaced apart from each other.

15. The image sensor of claim 12,
wherein first and second active regions in which the first and second pre-charge transistors are each formed are spaced apart from each other.

16. The image sensor of claim 15,
wherein a spaced distance between the first and second active regions is greater than a spaced distance between first and second gates of the first and second pre-charge transistors.

17. The image sensor of claim 12,
wherein the circuit part further comprises a second source follower that amplifies and outputs a signal corresponding to a change in potential of the first node, and
an extension length of each of the first and second pre-charge transistors is longer than an extension length of the second source follower.

18. The image sensor of claim 12,
wherein the circuit part further comprises:
a first capacitor connected to the first node, and a first sampling transistor that samples electric charges to the first capacitor,
a second capacitor connected to the first node, and a second sampling transistor that samples electric charges to the second capacitor, and
a third capacitor connected to the first node, and a third sampling transistor that samples electric charges to the third capacitor.

19. An image sensor comprising:
a first substrate including a pixel part comprising first and second pixel regions;
a second substrate bonded to the first substrate through a bonding structure, and includes a circuit part electrically connected to the first substrate; and
a third substrate electrically connected to the second substrate, on the second substrate,
wherein the pixel part comprises:
a photodiode,
a floating diffusion node which accumulates photocharges generated by the photodiode, and
a first source follower which amplifies and outputs a voltage of the floating diffusion node,
wherein the circuit part comprises:
a first capacitor that stores electric charges according to a voltage of the floating diffusion node being reset,
a second capacitor that stores electric charges according to the voltage of the floating diffusion node in which the photocharges are stored,
a first sampling transistor connected to a first node, and samples electric charges to the first capacitor,
a second sampling transistor connected to the first node, and samples electric charge to the second capacitor,
a first pre-charge selection transistor connected between the first node and a second node,
a second pre-charge selection transistor connected to the first pre-charge selection transistor, and
a pre-charge transistor which pre-charges the second node connected to the first source follower,
wherein the pre-charge transistor is disposed over first and second pixel regions that are adjacent to each other, on the second substrate.

20. The image sensor of claim 19,
wherein the first pre-charge selection transistor connected to the pre-charge transistor is disposed in the first pixel region, and
the second pre-charge selection transistor connected to the pre-charge transistor is disposed in the second pixel region.
